(19) United States
(12) Patent Application Publication
(10) Pub. No.: US 2025/0123095 A1
(43) Pub. Date: Apr. 17, 2025

(54) DYNAMIC INTERFEROMETER ILLUMINATOR

(71) Applicant: Zygo Corporation, Middlefield, CT (US)

(72) Inventors: Leslie L. Deck, Middletown, CT (US); James A. Soobitsky, Middlefield, CT (US)

(21) Appl. No.: 18/820,383

(22) Filed: Aug. 30, 2024

Related U.S. Application Data
(60) Provisional application No. 63/544,007, filed on Oct. 13, 2023.

(51) Int. Cl. G01B 9/02055; G01B 9/02

(52) U.S. Cl. CPC G01B 9/02067; G01B 9/02035

(57) ABSTRACT

Disclosed is an illumination system for an interferometer including: a source of system light; a steering-mirror assembly to receive and reflect the system-light in at least two orthogonal directions; a tracking mechanism to track an angular orientation of the steering-mirror assembly in the two orthogonal directions and provide electronic signals representative of the angular orientation; a focus lens assembly to focus the system light reflected off the steering mirror assembly onto a focused spot on a 2-dimensional plane corresponding to a source plane of the interferometer; and an electronic controller operatively coupled to the steering-mirror assembly and configured to cause the focused spot on the source plane to follow a predetermined motion trajectory.

### CROSS-REFERENCE TO RELATED APPLICATIONS

This application claims priority to provisional application No. 63/544,007 filed Oct. 13, 2023, the contents of which is incorporated herein in its entirety.

### TECHNICAL FIELD

This disclosure relates to optical interferometry.

### BACKGROUND

Interferometers are widely used tools for high-precision characterization of engineering surfaces. Surface profiling is one such application and interferometers are applied to analyze surface topographies over a broad range of spatial scales and resolutions. Interferometers designed for topographical analysis of moderate size (˜10 mm to >1m) optically smooth surfaces are employed because of their ease of use, speed, high (nm-level) precision and the non-contact nature of the measurement. Often incorporating phase-shifting interferometry (PSI) techniques, surfaces can be measured to fractions of a nanometer quickly and conveniently with no risk of damage to the high value surface.

These interferometers come in a variety of optical geometries that optimize different measurement characteristics. For example, a Michelson interferometer is illumination source friendly, accommodating a wide variety of source sizes and/or bandwidths, while a Twyman-Green geometry allows convenient access to the reference path. The laser has made the Fizeau geometry particularly popular for its ease of setup and common path architecture, which minimizes sensitivity to fabrication errors in the tool's optics. Combined with a laser, a Fizeau is ideally suited for the long optical paths one often encounters when characterizing large or complex optical assemblies.

Regardless of which architecture is used, these tools often have similar illumination configurations; the light source is focused to a point (or spot) situated in the back focal plane (BFP) of a lens (the collimator). A source spot is situated in the BFP and on the optical axis defined by the collimator creates a flat wavefront propagating parallel to the optical axis covering the full aperture. Changes in the wavefront after reflection from the surface(s) of interest are captured by a camera and analyzed to recover the surface topography, often using PSI techniques. Additional refractive/diffractive elements after the collimator provide alternative wavefronts to match different test surfaces; such as lenses for testing convex or concave spherical surfaces or computer generated holograms (CGH) for aspheric surfaces. In all cases the illumination source point should be stable to minimize error in the measurement process, and usually spatially limited to maximize wavefront quality and interference contrast, which directly affects measurement signal to noise ratio (SNR).

Static illumination source shapes other than single points are known to provide other advantages. For example, when using coherent illumination, stationary spatially extended disks with diameters greater than the spatial resolution limit of the interferometer have been used to reduce coherent noise, but the technique is limited to cavity optical thicknesses less than the longitudinal coherence limit defined by the disk size and optical system.

Other prior-art methods disclose source shapes different from single points or disks that provide advantages. One prior-art shape, a thin fixed radius ring (see U.S. Pat. Nos. 6,643,024 and 6,804,011) whose thickness is diffraction limited along the radial dimension and centered about the optical axis, provides coherent noise reduction without the cavity thickness limitations of a disk. These source shapes can be produced with either static or dynamic means. For example, a static ring shape can be produced with a holographic optical element or axicon. A static shape has the advantage of being physically stable and all points within the shape contribute to the interference simultaneously, but it has a disadvantage when used with coherent light due to mutual interference between different points in the source shape. Hence with coherent illumination, a static shape often requires additional optical elements to eliminate the extra interference produced by mutual coherence-such as a rotating diffuser, which is itself a dynamic element.

It can be more efficient and general to create source shapes dynamically with a moving point source that traces out the desired shape. This way arbitrary shapes can be produced with the same apparatus and each interferogram contains contributions from every point in the shape without mutual interference effects. A prior art method used with a ring shape is called CARS (coherent artifact reduction system), which consisted of averaging phase maps acquired sequentially from many positions distributed around the ring. Though effective, this stop-and-stare technique is slow. An alternative also described in the prior art is to dynamically trace the full ring shape within the frame integration time of the camera. This way each interferogram contains contributions from every point in the shape without mutual interference effects. This is a fast, efficient method but places greater demands on dynamic response.

What is lacking are ways to achieve the dynamic positioning precision and response needed to accurately and repeatably reproduce the desired shape within the integration time of the camera. Error in the shape or its reproducibility over time can introduce error in the optical path length difference (“OPD”) measurements when using phase-shifting techniques over the typical range of measurement conditions.

### SUMMARY

Disclosed herein is an illumination system for an interferometer including: a source of system light; a steering-mirror assembly to receive and reflect the system-light in at least two orthogonal directions; a tracking mechanism to track the steering-mirror assembly angular orientation in the two orthogonal directions and provide electronic signals representative of the angular orientation; a focus lens assembly to focus the system light reflected off the steering mirror assembly onto a 2-dimensional plane corresponding to the source plane of the interferometer; an electronic controller to operatively control the orientation of the steering-mirror assembly mirror with transducer elements attached to the mirror so that the focused spot on the source plane follows a predetermined motion trajectory.

Embodiments may further include any of: an interferometric optical system, receiving system-light from the illumination module which is directed to an interferometric cavity, and the reflected interfering light is captured by a camera whose output is sent to a computer; and a computer for data acquisition, trajectory selection/formation, and for processing the interference signal data to determine various metrology characteristics.

The steering mirror assembly may include a single 2-D steering mirror or two 1-D mirrors configured to steer the beam in two orthogonal angular directions;

The system may further include a focus lens assembly that has an NA high enough to assure a spot divergence sufficient to cover the desired interferometer aperture. Also the system may have a focus lens assembly that is telecentric

The system may further include a tracking mechanism intrinsic to the 2-D steering mirror that provides signals representative of the mirror orientation. For example, the tracking mechanism may include an additional control beam that reflects off the 2-D mirror and intersects a position sensitive detector (PSD) which is instrumented to provide electronic tracking signals representative of the mirror orientation. The tracking mechanism may also include an additional pickoff beam that directs part of the reflected system-light to a position sensitive detector (PSD) which is instrumented to provide electronic tracking signals representative of the beam orientation. The system may further include an electronic controller to operatively control the orientation of the steering mirror assembly. For example, the controller may be a controller that: 1) accepts operative trajectory information consisting of angle-time points representing steering mirror orientations during the trajectory; 2) changes the steering mirror orientation in time based on the provided trajectory; 3) reads the electronic signals representative of the actual steering mirror orientation at each time point; and/or 4) corrects the steering mirror orientation based on a feedback loop using the difference between the desired trajectory and the measured electronic signals representative of the actual steering mirror orientation as an error term in the feedback loop.

Furthermore, embodiments may include calibration methods to obtain the fixed characteristics that support all the needed functions, for example, finding the on-axis spot position on the PSD, mapping the relationship between the system beam and/or control beam orientation and the spot position on the source plane.

Accordingly, in one aspect, disclosed is an illumination system for an interferometer including: a) a source of system light; b) a steering-mirror assembly to receive and reflect the system-light in at least two orthogonal directions; c) a tracking mechanism to track an angular orientation of the steering-mirror assembly in the two orthogonal directions and provide electronic signals representative of the angular orientation; d) a focus lens assembly to focus the system light reflected off the steering mirror assembly onto a focused spot on a 2-dimensional plane corresponding to a source plane of the interferometer; and e) an electronic controller operatively coupled to the steering-mirror assembly and configured to cause the focused spot on the source plane to follow a predetermined motion trajectory.

Embodiments of the illumination system may include any of the following features.

The steering-mirror assembly may include at least one mirror and transducer elements, and wherein the electronic controller is configured to operatively control the orientation of the at least one mirror with the transducer elements. For example, the at least one mirror may include a single two-dimensional steering mirror or the at least one mirror includes two one-dimensional mirrors configured to steer the beam in two orthogonal directions.

The focus lens assembly may be telecentric.

The tracking mechanism may include electromechanical sensors or photoelectric sensors directly coupled with the steering-mirror assembly to provide the electronic signals representative of the angular orientation.

Tracking mechanism may include a position-sensitive detector to provide the electronic signals representative of the angular orientation. For example, the tracking mechanism further may include a control beam source to illuminate at least one mirror in the steering-mirror assembly with a control beam and subsequently detect the control beam with the position-sensitive detector to provide the electronic signals representative of the angular orientation. Or, the tracking mechanism may include an optic to pick-off a portion of the system-light reflected by the steering-mirror assembly and direct it to the position-sensitive detector to provide the electronic signals representative of the angular orientation.

The electronic controller may be further operatively coupled to the tracking mechanism, and wherein during operation the electronic controller corrects the angular orientation of the steering-mirror assembly based on a difference between a desired mirror orientation and the measured electronic signals of the mirror orientation provided by the tracking mechanism.

The electronic controller may store calibration information for mapping the angular orientation of the steering-mirror assembly to the location of the focus spot in the source plane of the interferometer.

The electronic controller may include a user interface for receiving information defining the predetermined motion trajectory.

The electronic controller may includes a memory for storing information defining the predetermined motion trajectory. For example, the predetermined motion trajectory may include multiple arcs having different radii from an optical axis of the interferometer. Also, for example, the predetermined motion trajectory may include multiple circles of different radii about an optical axis of the interferometer. Also, for example, the predetermined motion trajectory may include at least one spiral about an optical axis of the interferometer.

The source of system light may include a laser.

The interferometer be a Michelson interferometer, a Twyman-Green interferometer or a Fizeau interferometer.

The interferometer may be configured to illuminate a sample over an interferometer aperture with a wave front defined by the location of the focused spot in the source plane of the interferometer. For example, the focus lens assembly may define a numerical aperture (NA) providing a divergence of the focused spot sufficient to cover the aperture of the interferometer.

In another aspect, disclosed is an interferometric optical system including an interferometer and an illumination optical system, wherein the illumination optical system includes: a) a source of system light; b) a steering-mirror assembly to receive and reflect the system-light in at least two orthogonal directions; c) a tracking mechanism to track an angular orientation of the steering-mirror assembly in the two orthogonal directions and provide electronic signals representative of the angular orientation; d) a focus lens assembly to focus the system light reflected off the steering mirror assembly onto a focused spot on a 2-dimensional plane corresponding to a source plane of the interferometer; and e) an electronic controller operatively coupled to the steering-mirror assembly and configured to cause the focused spot on the source plane to follow a predetermined motion trajectory.

Embodiments of the interferometric optical system may include any of the features mentioned above for the illumination system in the illumination optical system for the interferometric optical system.

Other embodiments are also within the scope of this disclosure.

### DESCRIPTION OF DRAWINGS

FIG. 1 is a schematic of an embodiment of a dynamic illuminator using an internal tracking mechanism.

FIG. 2 is a schematic of an embodiment of a dynamic illuminator with a control beam tracking mechanism.

FIG. 3 is a schematic of an embodiment of a dynamic illuminator with pickoff beam tracking mechanism.

FIG. 4 is a schematic of an embodiment of a dynamic illuminator using two orthogonal 1-D mirrors with a pickoff beam tracking mechanism.

FIG. 5 is a schematic of an embodiment of a Fizeau interferometer configured with a dynamic illuminator.

FIG. 6 is geometry used to derive the dependence of the OPD to illumination angle α.

FIG. 7 is a block diagram for feedback control for the dynamic illuminator.

FIG. 8 is another block diagram for adaptive control for the dynamic illuminator.

### DETAILED DESCRIPTION

To create arbitrary shaped sources, it can be more efficient and general to create the shapes dynamically with a moving point source that traces out the desired shape within the integration time of the camera. The motion of the source point during this process is called the trajectory. Such a system can be enabled with a scanning mirror assembly with the mirror(s) actuated to tilt in 1 or more dimensions using high speed transducer elements (such as piezo-electric or voice coil transducers). The mirror angular changes are transformed into positional changes of the focused spot with a lens assembly. Arbitrarily shaped trajectories can be produced with the same apparatus and each interferogram contains contributions from every point in the shape without mutual interference effects.

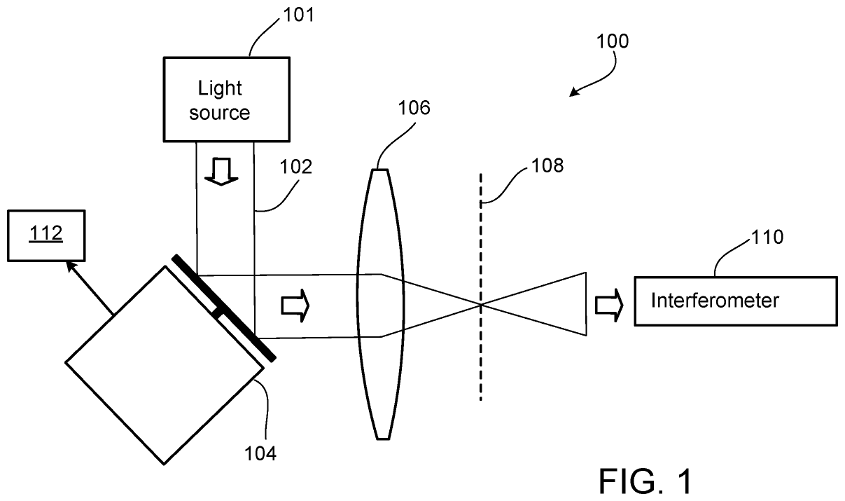

For example, one embodiment of a dynamic illuminator 100 is shown in FIG. 1. Specifically, a source beam 102 from a light source 101 is incident on a two-dimensional steering mirror 104 configured to adjustably redirect the source beam in two orthogonal directions. The redirected beam is focused on a lens (or lens system) 106 to a source plane 108 for a downstream interferometer 110. As will be explained further below, mirror orientation signals 112 indicating the actual setting for the two-dimensional beam steering mirror can provide signals to dynamically set the mirror and thereby the location of the beam in source plane 108. For example, in dynamic illuminator 100, the mirror orientation signals are provided by intrinsic signals within the beam steering mirror. For example, the intrinsic signals can be provided by electromechanical sensors, like linear variable differential transformers (LVDTs) or strain gauges that are sensors that physically contact the mirror to provide the intrinsic signals. For example, for a mirror manipulated via flexures, strain gauges attached to the flexure can use the strain measurement to deduce the angular position.

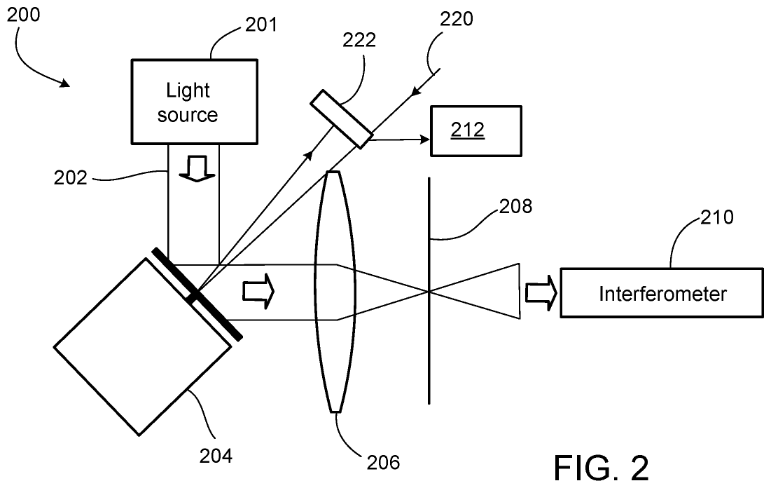

In other examples, the intrinsic signals can be provided by opto-electronic sensors. For example, if the back surface of the mirror is accessible, one could use triangulation internal to the assembly, similar to the embodiment shown in FIG. 2, except internally rather than externally. Also, differential intensity methods may used. For example, illuminating a diffusing region at the center of the mirror back surface and measuring the relative intensity difference of the reflection between multiple spatially separate sensors, such as a quadrant detector or image sensor or the like.

Using trajectories with different shapes can provide additional capabilities and functions:
As an alternative method of phase shifting in PSI (phase shifting interferometry)
As a means to reduce coherent noise from scattered light.
As an autofocus method assuming the gap is known
Synthesized spatial coherence properties
As a method for determining the optical distance between interfering surfaces
Increased measurable surface departure

A common requirement connecting all these functions is providing high trajectory precision and dynamic response while simultaneously and synchronously acquiring interferometric data from the test cavity. These trajectories often take the form of geometric primitives like points, lines, arcs, circles, and spirals. The dynamic illuminator herein provides for the precision and dynamic response needed for operable use of a dynamic illuminator source in an interferometer, thereby reducing error in the shape or its reproducibility over time that can otherwise introduce error in the interferometric metrology techniques applied to measure the test cavity over the wide range of measurement conditions.

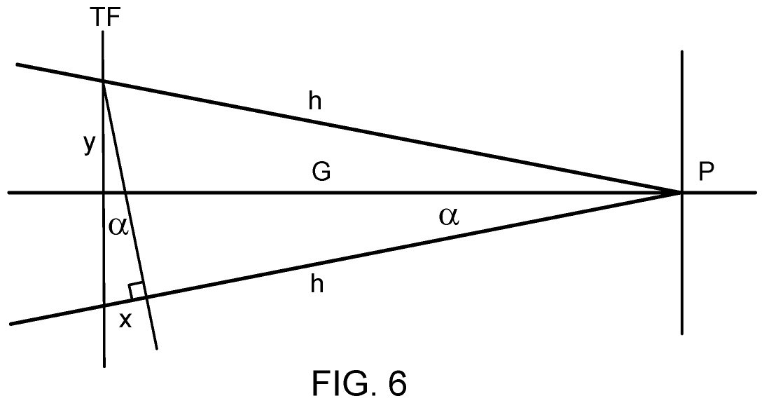

To estimate the required precision, consider the sensitivity of spot motion on the phase of the observed interference in an interferometer. An off-axis source point produces a tilted plane illumination wavefront after the collimator. Relative to an on-axis source point, the interference returning from a cavity illuminated by the tilted wavefront experiences a phase shift that depends on the illumination tilt and the cavity length. The relationship is derived with the aid of FIG. 6. Specifically, in FIG. 6, TF is a reference surface, G is the optical cavity length and α is the illumination angle of the wavefront in object space relative to the optical axis. Assuming point P is in focus, the interferometric total optical path difference (OPD) is

$$O P D = 2 h - x = 2 G ( \frac{1}{cos ( α )} - tan ( α ) sin ( α ) ) = 2 G cos ( α ) = 2 G ( 1 - \frac{{α}^{2}}{2} ) for α ≪ 1 \qquad ( 1 )$$

where sin α=x/2y and y=G tan α was used. The OPD sensitivity with respect to α is thus

$$\frac{dOPD}{d α} = G α \qquad ( 2 )$$

which for an optical cavity length of G=1 m is 1 nm/μrad. Since surface profiling interferometers routinely measure surfaces to nanometer level precision, angular noise levels of 10's of microradians or lower must be achieved while tracing a full trajectory within one camera frame.

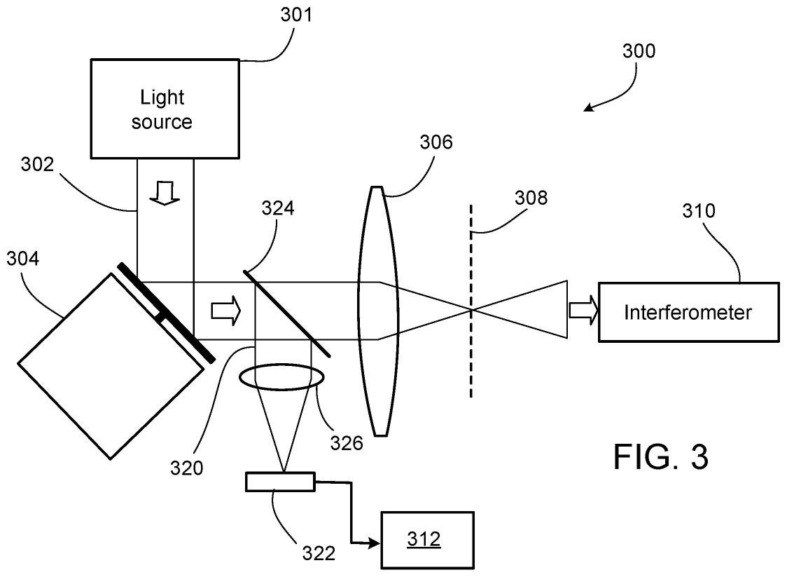

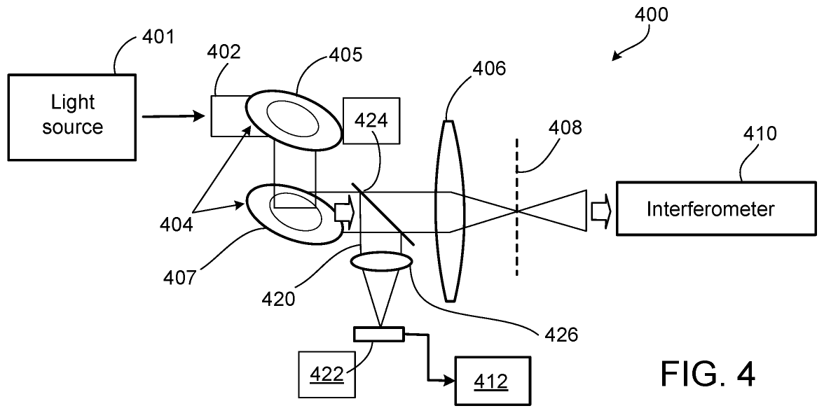

To achieve this precision, embodiments disclosed herein provide a closed-loop (feedback) control system that corrects the mirror position against a precise and stable measurement of the mirror's true angular orientation. In addition to the embodiment of FIG. 1, FIG. 2 and FIG. 3 show arrangements that can be used to enable high precision measurements of the mirror orientation, while FIG. 4 shows an embodiment that uses two orthogonal 1-dimensional scanning mirrors to achieve the mirror orientation in 2-dimensions. Deviations from the expected orientation are used as an error signal in the feedback loop to correct for deviations in the actual mirror orientation.

Specifically, in the embodiment of FIG. 2, a dynamic illuminator 200 similar to dynamic illuminator 100 is disclosed, where source beam 202 from a light source 201 is incident on a two-dimensional steering mirror 204 configured to adjustably redirected the source beam in two orthogonal directions. The redirected beam is focused on a lens (or lens system) 206 to a source plane 208 for a downstream interferometer 210. To provide the mirror orientation signals, instead of intrinsic control signals, the dynamic illuminator 200 includes a control beam 220 from control light source (not shown) that is incident on the two-dimensional steering mirror 204 and subsequently deflected to a position sensitive detector 222. The locations of the control beam 220 on the position sensitive detector 222 thereby provides the mirror orientation signals 212 indicating the actual setting for the two-dimensional beam steering mirror.

In the embodiment of FIG. 3, a dynamic illuminator 300 similar to dynamic illuminator 100 is disclosed, where source beam 302 from a light source 301 is incident on a two-dimensional steering mirror 304 configured to adjustably redirect the source beam in two orthogonal directions. The redirected beam is focused on a lens (or lens system) 306 to a source plane 308 for a downstream interferometer 310. To provide the mirror orientation signals, and instead of the intrinsic control signals, the dynamic illuminator 300 includes a slightly reflective pickoff mirror 324 to reflect a small portion of the re-directed source beam as a pick-off beam 320, which is then passes through a pick-off beam lens 326 and onto a position sensitive detector 322. The locations of the pick-off beam 320 on the position sensitive detector 322 thereby provides the mirror orientation signals 312 indicating the actual setting for the two-dimensional beam steering mirror.

As shown in the embodiment of FIG. 4, the steering mirror can also be implemented as a beam steering assembly to provide the two dimensional beam steering by, for example, using two one-dimensional beam steering mirrors. Specifically, a dynamic illuminator 400 similar to dynamic illuminator 300 is disclosed, where source beam 402 from a light source 401 is incident on a two-dimensional steering assembly 404 comprising a first one-dimensional beam steering mirror 405 and a second one-dimensional beam steering mirror 407, each configured to adjustably redirect the incident source beam in orthogonal directions. The redirected beam is focused on a lens (or lens system) 406 to a source plane 408 for a downstream interferometer 410. Like the embodiment of FIG. 3, to provide the mirror orientation signals, the dynamic illuminator 400 includes a slightly reflective pickoff mirror 424 to reflect a small portion of the re-directed source beam as a pick-off beam 420, which is then passes through a pick-off beam lens 426 and onto a position sensitive detector 422. The locations of the pick-off beam 420 on the position sensitive detector 422 thereby provides the mirror orientation signals 412 indicating the actual setting for the two-dimensional beam steering mirror. In certain embodiments, the measured orientation signal can be subtracted from an orientation command use to control the beam steering mirror (or equivalently the beam steering mirror assembly) to create an error signal fed to an electronic controller for the beam steering. The controller modifies the signals to the transducer or transducers that drive the beam steering mirror to effect a change in the orientation in response to the error. Random disturbances add to the change from the transducer and the system response changes the Orientation Signal in response. The command is followed within the loop bandwidth, which depends on the electromechanical response of the transducer and physical response of the mirror.

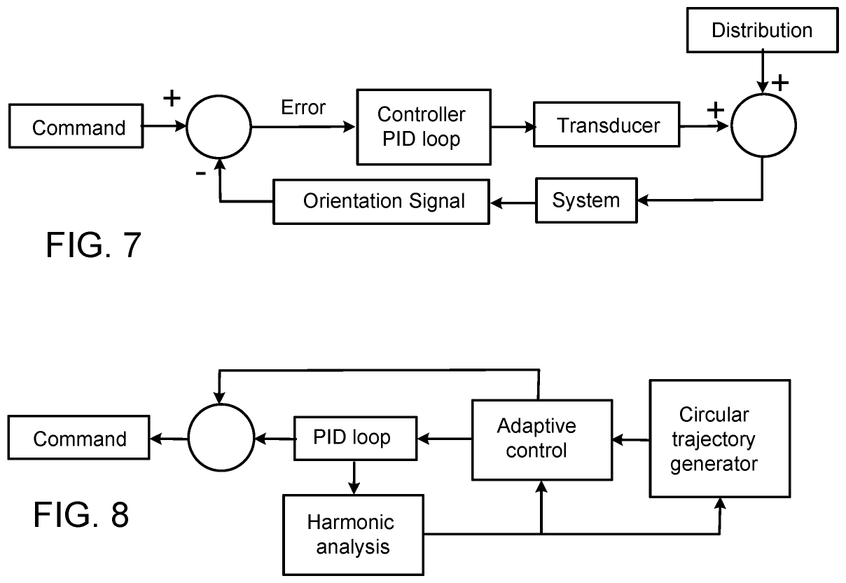

For example, FIG. 7 is a block diagram of a general feedback control system for the dynamic illuminator. A Command provides the desired orientation of the beam steering mirror, which is modified based on the measured Orientation Signals from the dynamic illuminator System (e.g., by subtraction) to create an Error signal that is fed to the Controller. The Controller modifies the Transducer to effect a change in the orientation in response to the error. Random Disturbances add to the change from the transducer and the system response changes the Orientation Signal in response. The command is followed within the loop bandwidth, which depends on the electromechanical response of the transducer and physical response of the mirror.

For specific trajectories the control block of FIG. 7 may be modified to account for physical characteristics of the trajectory. For example, if the trajectory is a ring, deviations from circularity occur as harmonics of the fundamental rate. One can take advantage of this with adaptive feedback based on the measured harmonics of the fundamental rate as determined from a Fourier analysis of the orientation signals over one or more cycles. This provides long term stability of both ring circularity and position; this is diagrammed in the control block of FIG. 8.

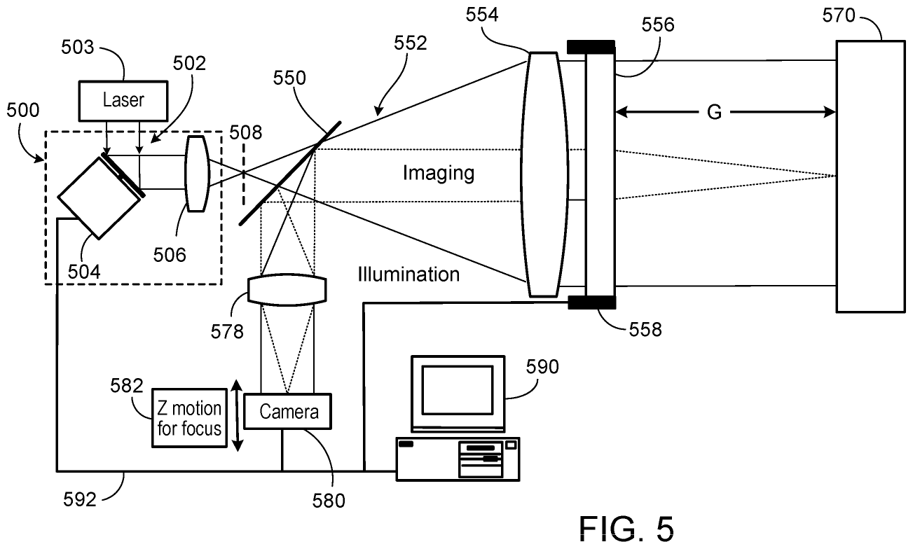

An embodiment showing the implementation of a dynamic illuminator in an exemplary interferometry system is shown in FIG. 5. Specifically, the system includes a dynamic illuminator 500, which receives a source beam 502 from a laser light source 503 and includes a two-dimensional steering mirror 504 configured to adjustably redirect the source beam in two orthogonal directions and a telecentric lens 506 to focus the redirected source beam onto a source plane 508. The interferometer includes a beam splitter 550 for passing the source light 552 toward the sample 570 (e.g., a test surface), and reflecting light being imaged from the sample 570 toward a camera 580. The interferometer also includes a collimator lens 554 for collimating the source light and reference flat 556, which partially reflects the source light to form a reference wavefront and partially transmits the source light to the sample 570, which reflects it to form a test wavefront. The reference and test wavefronts combine to form an interferogram that is imaged by imaging optic 578 onto camera 580. A translatable stage 582 supports the camera 580 so that the test surface can be properly focused onto the camera. A phase shifter 558 (e.g., a mechanical transducer) is coupled to the reference flat 556 to implement phase-shifting interferometry techniques that are well-known in the art. The cavity length G is defined by the optical distance between the reference flat and sample. A control system 590 is electronically coupled to the phase shifter and the detector for analyzing the interferograms. Moreover, the control system 590 provides control signals 592 for the controlling the orientation of the beam steering mirror 504. Furthermore, the dynamic illuminator may further include any of the techniques described above for monitoring the orientation of the beam steering mirror and implementing feedback to fine-tune any dynamic illumination, which is also controlled by control system 590. During operation the control system 590 can drive the transducers in the beam steering mirror 504 to cause the illumination beam spot in source plane 508 to move along a predetermined trajectory. Feedback control signals back to control system 590 as in any of the embodiments above can ensure that the desired trajectory is stable.

### Digital Implementations

The features of the controller can be implemented, at least in part, in digital electronic circuitry, or in computer hardware, firmware, or in combinations of these. For example, the features can be implemented in a computer program product tangibly embodied in an information carrier, e.g., in a machine-readable storage device, for execution by a programmable processor; and features can be performed by a programmable processor executing a program of instructions to perform functions of the described implementations by operating on input data and generating output. The described features can be implemented in one or more computer programs that are executable on a programmable system including at least one programmable processor, such as multiple processors, coupled to receive data and instructions from, and to transmit data and instructions to, a data storage system, at least one input device, and at least one output device. A computer program includes a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors one of multiple processors of any kind of computer. Generally, a processor will receive instructions and data from a read-only memory or a random access memory or both. Computers include a processor for executing instructions and one or more memories for storing instructions and data. Generally, a computer will also include, or be operatively coupled to communicate with, one or more mass storage devices for storing data files; such devices include magnetic disks, such as internal hard disks and removable disks; solid-state disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits). The features can implemented in a single process or distributed among multiple processors at one or many locations. For example, the features can employ cloud technology for data transfer, storage, and/or analysis.

Other embodiments are within the scope of the claims.

What is claimed is:

1. An illumination system for an interferometer comprising:
(a) a source of system light;
(b) a steering-mirror assembly to receive and reflect the system-light in at least two orthogonal directions;
(c) a tracking mechanism to track an angular orientation of the steering-mirror assembly in the two orthogonal directions and provide electronic signals representative of the angular orientation;
(d) a focus lens assembly to focus the system light reflected off the steering mirror assembly onto a focused spot on a 2-dimensional plane corresponding to a source plane of the interferometer; and
(e) an electronic controller operatively coupled to the steering-mirror assembly and configured to cause the focused spot on the source plane to follow a predetermined motion trajectory.

2. The system of claim 1, wherein the steering-mirror assembly comprises at least one mirror and transducer elements, and wherein the electronic controller is configured to operatively control the orientation of the at least one mirror with the transducer elements.

3. The system of claim 2, wherein the at least one mirror comprises a single two-dimensional steering mirror.

4. The system of claim 2, wherein the at least one mirror comprises two one-dimensional mirrors configured to steer the beam in two orthogonal directions.

5. The system of claim 1, wherein the focus lens assembly is telecentric.

6. The system of claim 1, wherein the tracking mechanism comprises electromechanical sensors or photoelectric sensors directly coupled with the steering-mirror assembly to provide the electronic signals representative of the angular orientation.

7. The system of claim 1, wherein the tracking mechanism comprises a position-sensitive detector to provide the electronic signals representative of the angular orientation.

8. The system of claim 7, wherein the tracking mechanism further comprises a control beam source to illuminate at least one mirror in the steering-mirror assembly with a control beam and subsequently detect the control beam with the position-sensitive detector to provide the electronic signals representative of the angular orientation.

9. The system of claim 7, wherein the tracking mechanism comprises an optic to pick-off a portion of the system-light reflected by the steering-mirror assembly and direct it to the position-sensitive detector to provide the electronic signals representative of the angular orientation.

10. The system of claim 1, wherein the electronic controller is further operatively coupled to the tracking mechanism, and wherein during operation the electronic controller corrects the angular orientation of the steering-mirror assembly based on a difference between a desired mirror orientation and the measured electronic signals of the mirror orientation provided by the tracking mechanism.

11. The system of claim 1, wherein the electronic controller stores calibration information for mapping the angular orientation of the steering-mirror assembly to the location of the focus spot in the source plane of the interferometer.

12. The system of claim 1, wherein the electronic controller comprises a user interface for receiving information defining the predetermined motion trajectory.

13. The system of claim 1, wherein the electronic controller comprises a memory for storing information defining the predetermined motion trajectory.

14. The system of claim 1, wherein the predetermined motion trajectory comprises multiple arcs having different radii from an optical axis of the interferometer.

15. The system of claim 1, wherein the predetermined motion trajectory comprises multiple circles of different radii about an optical axis of the interferometer.

16. The system of claim 1, wherein the predetermined motion trajectory comprises at least one spiral about an optical axis of the interferometer.

17. The system of claim 1, wherein the source of system light comprises a laser.

18. The system of claim 1, wherein the interferometer is a Michelson interferometer, a Twyman-Green interferometer or a Fizeau interferometer.

19. The system of claim 18, wherein the interferometer is configured to illuminate a sample over an interferometer aperture with a wave front defined by the location of the focused spot in the source plane of the interferometer.

20. The system of claim 19, wherein the focus lens assembly defines a numerical aperture (NA) providing a divergence of the focused spot sufficient to cover the aperture of the interferometer.

21. An interferometric optical system comprising an interferometer and an illumination optical system, wherein the illumination optical system comprises:
(a) a source of system light;
(b) a steering-mirror assembly to receive and reflect the system-light in at least two orthogonal directions;
(c) a tracking mechanism to track an angular orientation of the steering-mirror assembly in the two orthogonal directions and provide electronic signals representative of the angular orientation;
(d) a focus lens assembly to focus the system light reflected off the steering mirror assembly onto a focused spot on a 2-dimensional plane corresponding to a source plane of the interferometer; and
(e) an electronic controller operatively coupled to the steering-mirror assembly and configured to cause the focused spot on the source plane to follow a predetermined motion trajectory.
